(19) United States
(12) Patent Application Publication
(10) Pub. No.: US 2015/0027314 A1
(43) Pub. Date: Jan. 29, 2015

(54) AIR FILTER APPARATUS WITH ADHESIVE AIR FILTER (ADAF) AND COMPONENTS FOR AIR PURIFICATION, AND SYSTEMS USING THE SAME

(71) Applicant: Gregory T. Kavounas, Bellevue, WA (US)

(72) Inventor: Gregory T. Kavounas, Bellevue, WA (US)

(21) Appl. No.: 14/340,552

(22) Filed: Jul. 24, 2014

Related U.S. Application Data
(60) Provisional application No. 61/858,377, filed on Jul. 25, 2013.

(51) Int. Cl. B01D 45/08; B01D 50/00

(52) U.S. Cl. CPC B01D 45/08; B01D 50/002
USPC 96/418; 55/437; 55/332; 55/351

(57) ABSTRACT

In embodiments, an air filter apparatus includes a base structure (210), an air propulsion mechanism (220), and an adhesive air filter (ADAF) (240) that has an adhesive surface (242). The air propulsion mechanism may establish an air flow (252, 254, 256, 258). The base structure may be configured such that the air flow goes past a vicinity (222) of the adhesive air filter (240), and at least some of the particulates (262, 264) in the flowing air impact the adhesive surface (242), and thus become adhered to it and captured by it. The adhesive air filter could be made from commercially available adhesive tape that is discarded when saturated. Since it is impervious to air, small particulates can be captured upon impact economically. Embodiments may purify the air in enclosed spaces such as homes, offices, and passenger compartments, preventing health problems. Embodiments may further reduce pollution from chimneys.

### CROSS REFERENCE TO RELATED PATENT APPLICATIONS

This patent application claims priority from U.S. Provisional Patent Application Ser. No. 61/858,377, filed on Jul. 25, 2013, the disclosure of which is hereby incorporated by reference for all purposes.

### BACKGROUND

Air filters are used to purify air that has been polluted, and render it more suitable for breathing. Air filters are also used to purify air in instances where industrial processes are performed. An example is now described.

Referring to FIG. 1A, a conventional air filter apparatus 100 is shown. Air filter apparatus 100 includes a fan 120 and an air filter 130. Optionally, air filter apparatus 100 includes a duct 112.

Fan 120 establishes an air flow through air filter 130. In FIG. 1A the air flow has portions 152, 154, 156, 158. When duct 112 is provided, fan 120 and air filter 130 are often provided within duct 112, or near the ends of duct 112. In addition, air flow portions 154 and 156 are established in duct 112.

Air filter 130 filters, and thus purifies, the air in air flow 154. In other words, due to air filter 130, the air of air flow portions 156, 158 is more purified than the air of air flow portions 152, 154. The filtering is depicted in FIG. 1A by showing what happens with various particulates that are suspended in the air of the air flow, and are moved due to the air flow. More particularly, air flow portion 152 is indicated as an arrow that contains two sample smaller particulates 162 and two sample larger particulates 164. Air flow portion 158 is indicated as an arrow that contains only the two smaller particulates 162. The two larger particulates 164 of air flow portion 152 are shown as captured by air filter 130, and therefore are not indicated in air flow portion 158.

In air filter apparatus 100, the air is transmitted through air filter 130. Filtering operates because of this transmission. Accordingly, air filter 130 can be called a transmissive air filter.

It is useful that transmissive air filter 130 captures particulates 164. Of course, conventional transmissive air filters can capture many of the larger particulates.

It is understood, however, that conventional transmissive air filters permit smaller particulates 162 to go through them, because they have to allow at least some of the air to go through them.

Different conventional filters perform differently. One way to describe their differences is to compare their performance in a single diagram. An example is now described.

FIG. 1B is a diagram for comparing the performances and ratings of conventional air filters. The horizontal axis describes the size of particulates in the air of the air flow that is transmitted through the filter. Five sample particulates 161, 162, 163, 164, 165 are further shown, of progressively increasing sizes.

The vertical axis of FIG. 1B describes what fraction of the particulates is captured by the conventional filters, for example as a percentage. The fraction is zero at the origin, and then it increases to a high value, nearing 1 or 100% as is desired.

In addition characteristic lines are shown that describe the performances of various air filters. For example, air filter 130 has a characteristic line 131. As characteristic line 131 describes, air filter 130 captures a very large fraction of larger particulates 164, 165 while it captures decreasing fractions of smaller particulates 163, 162, 161.

Characteristic line 131 is curved and spans a number of values along the horizontal axis. It is often desirable to express it by a single number. Accordingly, a point in characteristic line 131 is chosen and projected on the horizontal axis at value 191. Value 191 is often called the rating of filter 130.

Recently, attention has been drawn to air pollution that includes particulates suspended in air that are smaller and smaller. Since they are smaller, they tend to escape conventional filters, for example as most particulates 162 escape air filter 130. Particulates whose diameter is smaller than 2.5 μm are called 2.5 PM. Such smaller particulates can cause respiratory and other health problems to people.

It is possible to construct transmissive air filters that can capture smaller and smaller particulates. For example, a new air filter could be constructed that is intended to capture particulates 162, 163, 164, 165. This new air filter could have a characteristic line 132, and accordingly a rating of value 192, which is improved over value 191 of the rating of filter 130.

Such a new air filter would be more expensive than filter 130. In addition, the new air filter could offer more resistance to air being forcibly transmitted through it. Accordingly, such a new air filter could require a larger fan 120, and further more power to operate it. These are some of the reasons why filtering smaller particulates out of the air can become expensive for daily human use. These considerations become even larger when clean rooms are constructed and operated for industrial processes sensitive to contamination.

### BRIEF SUMMARY

The present description gives instances of air filter apparatuses and components for air purification, and systems that use them, which may help overcome problems and limitations of the prior art.

In embodiments, an air filter apparatus collects particulates that are suspended in air. The air filter apparatus may include a base structure, an air propulsion mechanism, and an adhesive air filter (ADAF) that has an adhesive surface. The air propulsion mechanism may establish a flow of the air. The base structure may be configured such that the air flow goes past a vicinity of the adhesive air filter, and at least some of the particulates in the flowing air impact the adhesive surface of the adhesive air filter, and thus become adhered to it and captured by it.

Embodiments include air filters for many uses, such as stand-alone, for air conditioners, for ground vehicles and airplanes to purify the air in their passenger compartments, for rooms in health care facilities where sensitive medical procedures are performed, for clean rooms where sensitive industrial processes are performed, for placing at chimneys of houses and factories to reduce air pollution, and so on. Stand-alone embodiments may purify the air in enclosed and important spaces such as homes and places of work, whose air may become contaminated from wood burning stoves, fireplaces, or just opening the windows in polluted locations.

An advantage may occur since such an air filter can capture harmful particulates that could have caused respiratory problems, and yet are so small that they could escape conventional inexpensive transmissive air filters of inadequate rating.

Another advantage may occur since embodiments are easy to implement when the adhesive air filter is made from adhesive tape that is already commercially available, and easy to procure at low cost. In addition, very simple embodiments can require a fan of a lesser power, because they are not pushing air through a conventional transmissive air filter, and therefore there can be less air resistance for attaining the same effective performance rating.

In embodiments, the adhesive air filter is impervious to air. Accordingly, much smaller particulates can be captured upon impact, due to the lack of transmission effects.

Moreover, the apparatus can be made with geometries that can cause the air flow to impact the adhesive surface multiple times, so as to improve capture of the particulates upon each pass through the apparatus.

These and other features and advantages of this description will become more readily apparent from the Detailed Description, which proceeds with reference to the associated drawings in which:

### BRIEF DESCRIPTION OF THE DRAWINGS

FIG. 1A is a diagram of an apparatus that uses a conventional air filter.

FIG. 1B is a diagram for comparing the performances and ratings of conventional air filters.

FIG. 2 is a diagram of sample components of an air filter apparatus made according to embodiments.

FIG. 3 is a diagram of sample components of an air filter apparatus made according to embodiments.

FIG. 4 is a diagram of sample components of an air filter apparatus made according to embodiments.

FIG. 5 is a diagram of sample components of an air filter apparatus made according to embodiments.

FIG. 6 is a diagram of sample components of an air filter apparatus made according to embodiments.

FIG. 7 is a diagram of sample components of an air filter apparatus made according to embodiments.

FIG. 8 is a diagram of sample components of an air filter apparatus made according to embodiments.

FIG. 9 is a diagram of sample components of an air filter apparatus that further includes a transmission air filter according to embodiments.

FIG. 10 is a diagram of sample components of an air filter apparatus that further includes a roll of an adhesion air filter and the base presents a dispenser arrangement according to embodiments.

FIG. 11 is a time diagram for illustrating progressive saturation of an adhesive air filter.

FIG. 12 is a diagram of sample components of an air filter apparatus that further includes an optical detector made according to embodiments.

FIG. 13 is a diagram of sample components of an air filter apparatus that further includes an optical detector made according to embodiments.

FIG. 14 is a diagram of sample components of an air filter apparatus that further includes a motor and a bobbin to change the filter mechanically according to embodiments.

FIG. 15 is a diagram of sample components of an air filter apparatus where the adhesive air filter is provided as a tape in a cassette according to embodiments.

FIG. 16 is a diagram of a sample health care facility with an operation room that uses an air filter apparatus made according to embodiments.

FIG. 17 is a diagram of a sample building with a clean room that uses an air filter apparatus made according to embodiments.

FIG. 18A is a perspective diagram of a sample stand-alone air filter apparatus made according to embodiments.

FIG. 18B is a section side view of the stand-alone air filter apparatus of FIG. 18A.

FIG. 19 is a diagram of sample components of an air conditioning system that further includes an air filter apparatus according to embodiments.

FIG. 20 is a diagram of sample components of an air conditioning system that further includes an air filter apparatus according to embodiments.

FIG. 21 is a diagram of a sample vehicle equipped with an air filter apparatus for purifying the air of the interior according to embodiments.

### DETAILED DESCRIPTION

As has been mentioned, the present description is about air filter apparatuses and components for air purification, and systems that use them. Embodiments are now described in more detail, first by explaining operations of certain components.

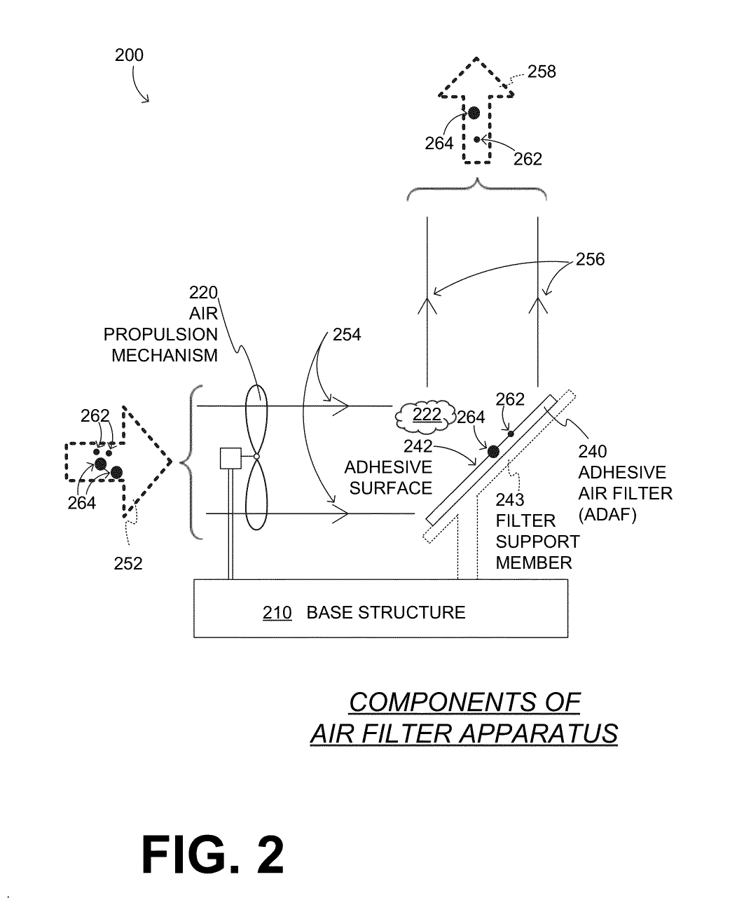

FIG. 2 is a diagram of components 200 of an air filter apparatus made according to embodiments. It will be understood that components 200 may be implemented in a wide variety of embodiments and systems.

Components 200 include a base structure 210. Base structure 210 can be implemented in any number of ways. A number of these ways are described in more detail later in this document. Briefly, base structure 210 can be part of a host system that includes the air filter apparatus. For example, base structure 210 can include a housing for standalone air filter embodiments, or for air conditioning units that also include an air filter, or for air heating units that also include a standalone air filter. For one more example, base structure 210 can be integrated with otherwise air filter systems of rooms where medical procedures or industrial processes are performed, in which high air purity is useful to prevent contamination. For an additional example, base structure 210 can be part of a vehicle or other machine for transportation, which includes an air filter for purifying the air of the passenger cabin. For a further example, base structure 210 can be part of a chimney of a home or a factory, to reduce the number of harmful particulates emitted to the environment.

Components 200 also include an air propulsion mechanism 220. Air propulsion mechanism 220 can be implemented in any number of ways known in the art that are suitable for moving air. Typically, air propulsion mechanism 220 is implemented by a fan as shown. In some embodiments, such as in conjunction with an air conditioning system, air propulsion mechanism 220 is already provided.

Air propulsion mechanism 220 can be coupled to base structure 210. Coupling can be by attachment. In some embodiments, base structure 210 or air propulsion mechanism 220 can include a protective cage around the fan.

Components 200 additionally include an adhesive air filter 240 according to embodiments. Adhesive air filter 240 can be coupled to base structure 210. Coupling can be by attachment or other ways, in view of how other components are implemented. Adhesive air filter 240 may include an adhesive surface 242, which is described in more detail later.

Air propulsion mechanism 220 can be configured to establish a flow of the air, which is also called an air flow. The air flow can go in a number of different directions, and is shaped by how base structure 210 is implemented. In embodiments, base structure 210 is such that the air flow goes past a vicinity 222 of adhesive air filter 240, for filtering to be performed. As will be seen later from possible configurations of the base structure, filtering can be more effective if the air flow does not reach only the vicinity of adhesive air filter 240, but also impacts it in such a way as to be deflected from it.

In the example of FIG. 2, the air flow has portions 252, 254, 256, 258. In FIG. 2, different icons are used to depict different portions of the air flow, depending on what needs to be illustrated in each instance. Arrows 252, 258 are used to depict respectively air flow portions 252 and 258, so that filtering effects can be illustrated better. Additionally, lines 254 and lines 256 are used to depict air flow portions in vicinity 222 of adhesive air filter 240, so that deflecting the air flow can be illustrated better.

In the example of FIG. 2, air propulsion mechanism 220 establishes the air flow by pushing the air towards vicinity 222. It will be understood that the air propulsion mechanism could instead be configured to pull air from vicinity 222, or that a system of two fans could be implemented, one that pushes and one that pulls, and so on.

Embodiments can be implemented for enclosures where it is important to protect the quality of the air. Examples of such enclosures are homes, offices, passenger compartments of vehicles and other machines for transportation, health care facility rooms for medical procedures, and clean rooms for sensitive industrial processes. In such embodiments, the flow can go from the enclosure according to air flow portion 252, past vicinity 222 of adhesive air filter 240, and then back to the enclosure according to air flow portion 258. After some time of operation, the quality of the air that is in the enclosure may thus be improved.

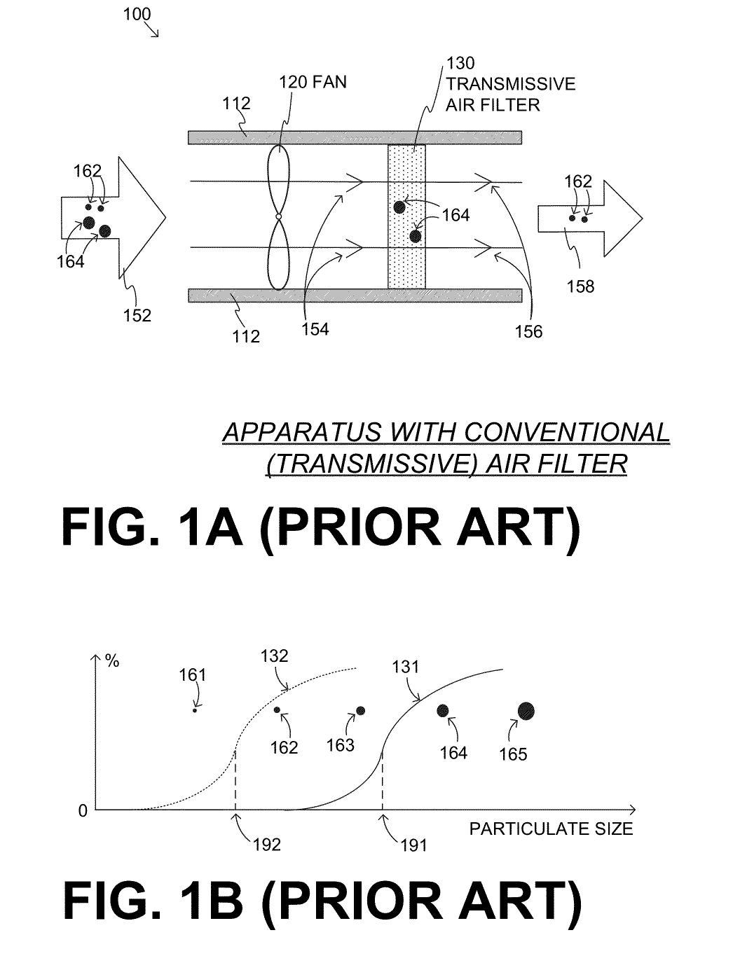

It will be observed that, unlike with FIG. 1A, in the example of FIG. 2 air flow portions 256 and 258 are in a different direction than air flow portions 252 and 254. The reason is that the established air flow is ultimately deflected by adhesive air filter 240. More particularly, the air flow is deflected by adhesive air filter 240, from going substantially along a first direction to going substantially along a second direction. Here the first direction is that of air flow portion 254, and the second direction is that of air flow portion 256. In general, the second direction changes course by at least 30° from the first direction. In the particular example of FIG. 2, the second direction changes course by approximately 90° from the first direction. Implementing a deflection, however, is not necessary as will be seen later in this document.

The established air flow can be such that at least some of the particulates of the air in the air flow impact adhesive surface 242, and are therefore captured by the adhesive surface 242. In fact, adhesive surface 242 can be configured to capture at least a fraction of any of the particulates of the air in the air flow that impact adhesive surface 242 at a certain angle, and belong in a size range of interest. Advantageously, the range of interest can include small sizes, which would improve the performance rating.

The fraction can be higher than a few percent, for example higher than 3% or 5%. This percentage is understood as a fraction of those particulates that are in the air of the air flow, as opposed to those that might strike adhesive surface 242 due to random motion, such as Brownian motion. For determining the percentage, first the concentration of particulates in the size range of interest per volume of may be determined. Then a volume of the air flow with respect to time may be also determined. Then a number of particulates within the volume that impact the air filter at a certain angle may be determined accordingly, and so on.

Capturing may be performed due to adhesion. Larger particulates, which present more surface area, may have a better chance of being captured by adhesive surface 242. In addition, capturing may be improved with the choice of adhesive that has a larger bonding force, as will be evident to a person skilled in the art.

In the particular example of FIG. 2, entering air flow 252 is shown as including two sample small particulates 262 and two sample large particulates 264. Adhesive surface 242 is shown as having captured one small particulate 262 and one large particulate 264. The remaining particulates are shown in exiting air flow 258. Therefore, adhesive air filter 240 performs filtering and purifying of the air.

Adhesive air filter 240 and adhesive surface 242 may be implemented in a number of ways. In some embodiments, adhesive air filter 240 is substantially impervious to air, although that is not necessary. In some embodiments, adhesive surface 242 itself is substantially impervious to air. In some embodiments, adhesive air filter 240 is flexible. Adhesive air filter 240 and adhesive surface 242 may be implemented by depositing an adhesive material such as glue on an otherwise inert substrate.

In some embodiments, adhesive air filter 240 may be implemented by commercially available flexible adhesive tape such as Scotch® tape, tape used to seal carton boxes, and so on. These embodiments have the advantage that they are commercially available, light weight, very economical to procure, and have strong adhesives already prepared on them, which can be exposed by peeling. In some embodiments, existing sizes of such tape may guide the dimensions of the air filter. In some embodiments, the air filter apparatus will be designed first, and a suitable size of the adhesive tape can be ordered, as will be apparent to a person skilled in the art in view of the present description.

In some embodiments, an optional filter support member 243 is used. Filter support member 243 can perform a number of functions. In some embodiments, filter support member 243 couples adhesive air filter 240 to base structure 210. In some embodiments where adhesive air filter 240 is flexible, filter support member 243 is configured to maintain adhesive air filter 240 substantially immobile, notwithstanding the pressure from the air flow. In other words, filter support member 243 can prevent adhesive air filter 240 from being displaced or pushed backwards, when adhesive air filter 240 is subjected to the force of air flow 254. In some embodiments this force will not be large, and perhaps filter support member 243 will not be needed.

In some embodiments, filter support member 243 permits light to go through it. In other words, filter support member 243 can be translucent or even transparent. This will help for being able to determine whether adhesive air filter 240 has been saturated and needs to be replaced, as will be seen later in this description.

In the particular example of FIG. 2, no duct was shown among components 200. In some embodiments, the base structure optionally includes a duct that is configured to confine at least a portion of the flow of the air. Examples are now described. In these examples, a duct may be tubular, have one or more planar components, have a cross section that includes curves or lines, and so on.

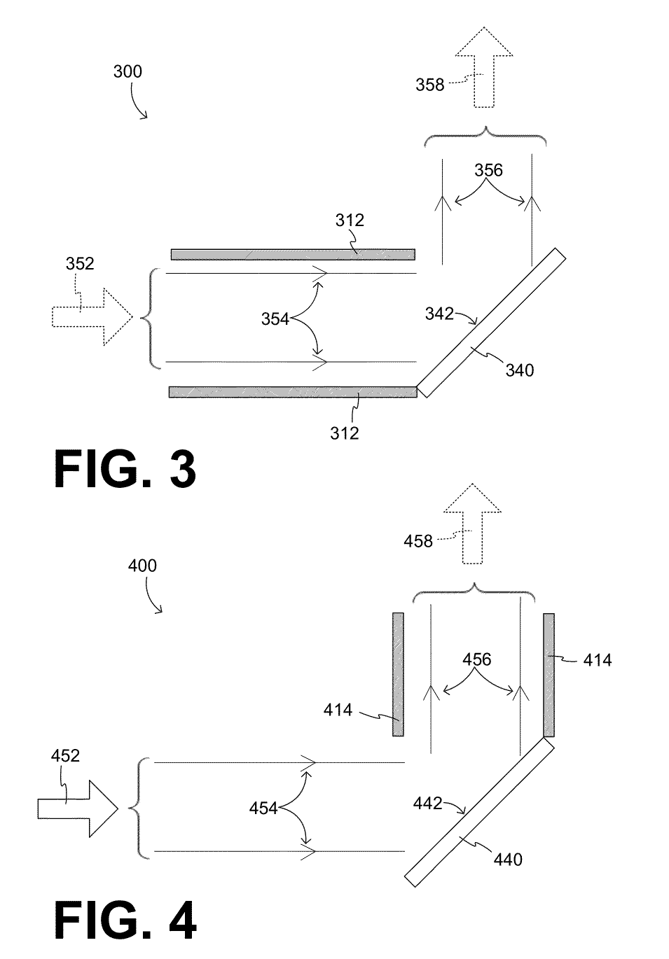

FIG. 3 is a diagram of components 300 of an air filter apparatus made according to embodiments. Components 300 include an adhesive air filter 340 that has an adhesive surface 342, and which can be similar to air filter 240. An air propulsion mechanism (not shown) establishes an air flow having portions 352, 354, 356, 358. A duct 312 confines portion 354 of the air flow. Duct 312 occurs before the vicinity of filter 340 in the air flow. The vicinity is not designated specially.

FIG. 4 is a diagram of components 400 of an air filter apparatus made according to embodiments. Components 400 include an adhesive air filter 440 that has an adhesive surface 442, and which can be similar to air filter 240. An air propulsion mechanism (not shown) establishes an air flow having portions 452, 454, 456, 458. A duct 414 confines portion 456 of the air flow. Duct 414 occurs after the vicinity of filter 440 in the air flow. The vicinity is not designated specially.

In some embodiments, the duct is configured to progressively constrict at least a portion of the flow of the air. An example is now described.

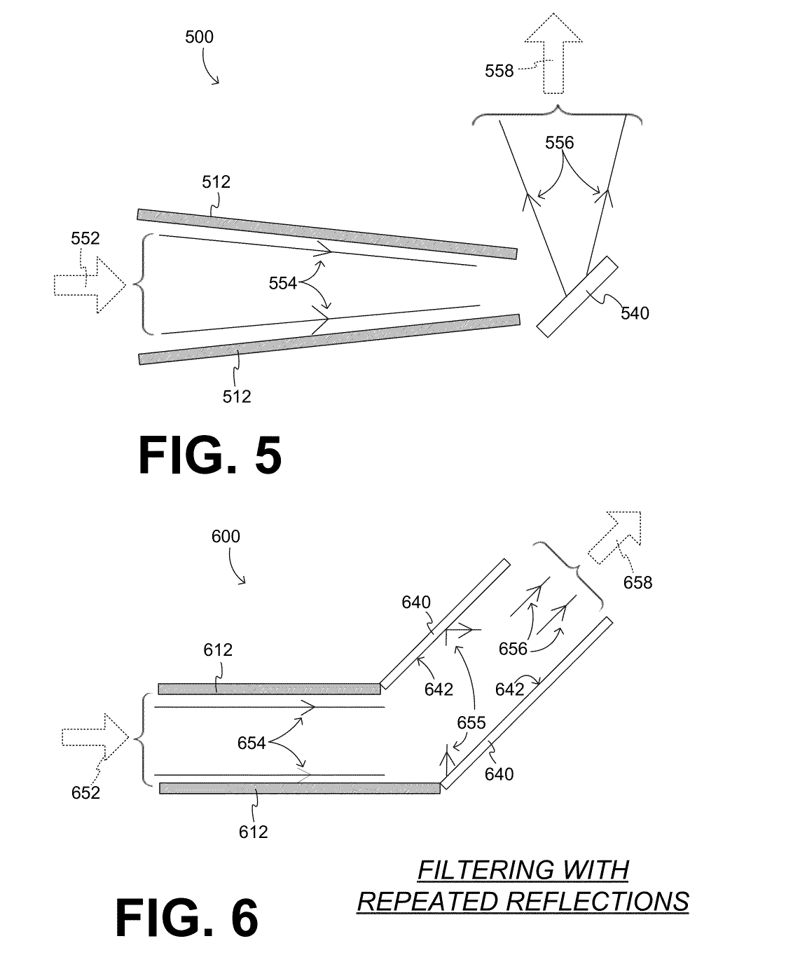

FIG. 5 is a diagram of components 500 of an air filter apparatus made according to embodiments. Components 500 include an adhesive air filter 540 that can be similar to air filter 240. An air propulsion mechanism (not shown) establishes an air flow having portions 552, 554, 556, 558. A duct 512 confines portion 554 of the air flow, and progressively constricts it. An advantage is that a smaller adhesive air filter 540 need be used than in FIG. 3. It is preferred to additionally consider the likely trajectories of particulates of interest within the air flow. For example, if these trajectories follow the direction of air flow 554 only approximately, then the particulates of interest may experience multiple reflections of decreasing step inside duct 512, and may even reverse course before reaching air filter 540. The phenomenon may be exacerbated if duct 512 progressively constricts also in the side dimensions, not just the top and bottom seen in FIG. 5.

In some embodiments, the duct is configured to cause at least some of the particulates within the air of the air flow to impact the adhesive surface at least twice. Such geometries create more opportunities for a single particulate to be captured by adhesion in a single pass through the apparatus. Examples are now described.

FIG. 6 is a diagram of components 600 of an air filter apparatus made according to embodiments. Components 600 include adhesive air filters 640 that have respective adhesive surfaces 642, and which can be similar to air filter 240. An air propulsion mechanism (not shown) establishes an air flow having portions 652, 654, 656, 658. A duct 612 confines portion 654 of the air flow. In addition, adhesive air filters 640 are extended, and contribute to forming another duct that confines air flow portion 656. Moreover, the direction of air flow portion 656 changes course by 45° from the direction of air flow portion 654.

It should be understood that air flow portion 656 is considered macroscopically. Within it, individual particulates may be caused to impact adhesive surfaces 642 multiple times in a single pass, for example as shown in trajectories 655. These trajectories 655 correspond to successive deflections at incident angles of 45°.

For implementing components 600, and also those in other examples, adhesive air filters 640 might be planar, and the cross section of the duct for air flow portion 656 might be rectangular.

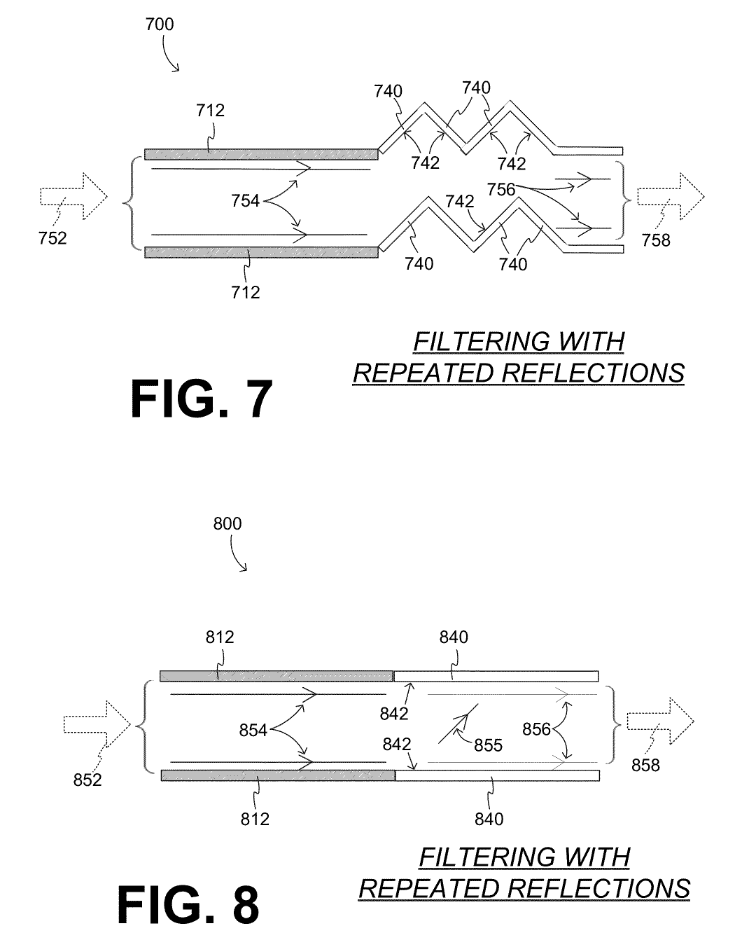

FIG. 7 is a diagram of components 700 of an air filter apparatus made according to embodiments. Components 700 include adhesive air filters 740 that have respective adhesive surfaces 742, and which can be similar to air filter 240. An air propulsion mechanism (not shown) establishes an air flow having portions 752, 754, 756, 758. A duct 712 confines portion 754 of the air flow. In addition, adhesive air filters 740 contribute to forming another duct that is jagged, and confines air flow portion 756. The direction of air flow portion 756 changes course multiple times, which causes particulates within the air of the flow to impact adhesive surfaces 742 multiple times. Exiting air flow 758 could have the same direction as entering air flow 752 as shown, or a different direction.

FIG. 8 is a diagram of components 800 of an air filter apparatus made according to embodiments. Components 800 include adhesive air filters 840 that have respective adhesive surfaces 842, and which can be similar to air filter 240. An air propulsion mechanism (not shown) establishes an air flow having portions 852, 854, 856, 858. A duct 812 confines portion 854 of the air flow. In addition, adhesive air filters 840 form part of another duct that air flow portion 856. In this example, macroscopically speaking, the direction of the air flow does not change course. Still, individual particulates may impact adhesive surfaces 842 multiple times, if they are traveling along slanted trajectories within the air flow, such as trajectory 855.

Adhesion air filters according to embodiments may become saturated after prolonged use, in which case they may need replacement. For example, attention is drawn again to FIG. 2, in which adhesive surface 242 has captured smaller particulate 262 and larger particulate 264. After more use, more of these particulates will be captured, ultimately covering more of adhesive surface 242, and making less of it available for filtering.

In some embodiments, an air filter apparatus also includes a transmissive air filter, preferably before the adhesive air filter within the air flow. In these embodiments, at least a part of the air flow is established through the transmissive air filter, in order to capture at least the larger air particulates. An example is now described.

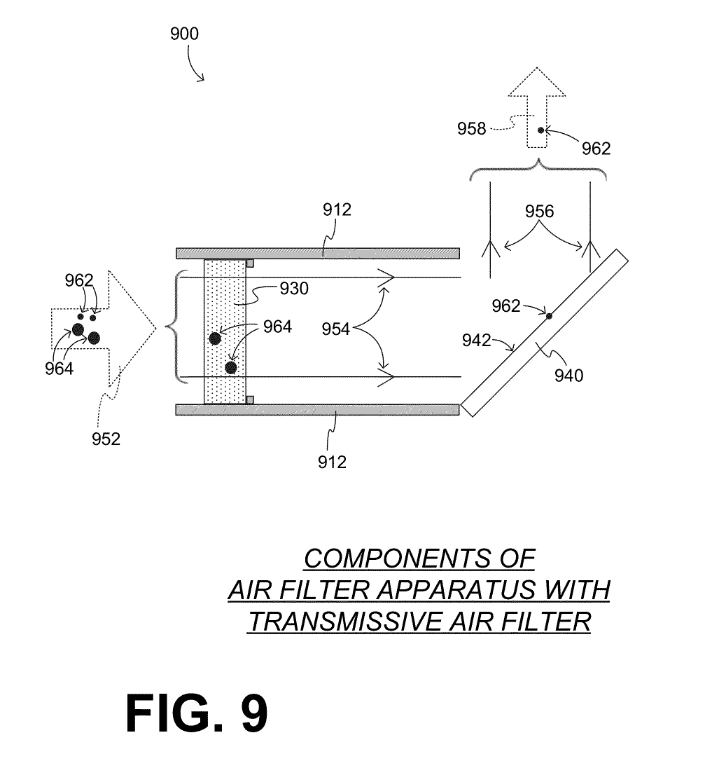

FIG. 9 is a diagram of components 900 of an air filter apparatus according to embodiments. Components 900 include an adhesive air filter 940 that has an adhesive surface 942, and which can be similar to air filter 240. An air propulsion mechanism (not shown) establishes an air flow having portions 952, 954, 956, 958.

A duct 912 confines portion 954 of the air flow. A transmissive air filter 930, which could be made similarly to filter 130, is provided within duct 912. Air flow portion 954 is forced to go through transmissive air filter 930.

Air flow portion 952 includes two smaller particulates 962, and two larger particulates 964. Larger particulates 964 are captured by transmissive air filter 930. One of the smaller particulates 962 is captured by adhesive surface 942, while the other one exits in air flow portion 958. Filtering therefore occurs both by adhesive air filter 940 and transmissive air filter 930. In addition, adhesive surface 942 can be exposed to fewer of the larger particulates 964, and therefore can last longer before becoming saturated.

Embodiments for replacing the adhesive air filter are now described. The adhesive air filter may be replaced in any way that works well with the remainder of the implementation, and any host system if provided.

In a number of embodiments, the adhesive air filter is provided in the form of tape wound in a roll. Pieces of it can be cut and applied to the air filter apparatus. In fact, the base structure can further include a blade for cutting a segment of the tape that is intended for use, or after it has been used. Moreover, the base structure can be implemented to present a dispenser arrangement for storing and cutting the tape. In the dispenser arrangement, the base structure can be configured to support the roll, and so on. Examples are now described.

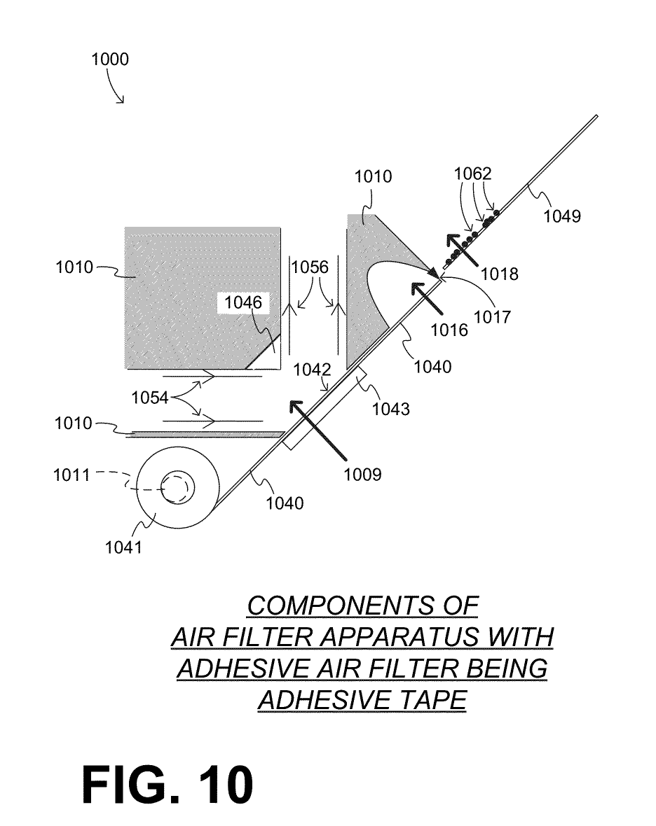

FIG. 10 is a diagram of components 1000 of an air filter apparatus according to embodiments. A base structure 1010 is provided, of which various parts are shown. Base structure 1010 defines ducts in which an air propulsion mechanism (not shown) can establish an air flow with portions 1054, 1056. A window 1009 in base structure 1010 is covered by an adhesive air filter 1040 that is provided in the form of a tape wound in a roll 1041. Covering need not be airtight; in fact, tape 1040 need not make contact with base structure 1010 around window 1009.

Base structure 1010 presents a dispenser arrangement by being configured to support roll 1041. There are a number of ways that this can be accomplished. For example, roll 1041 can be contained in its own compartment. In the shown example, base structure 1010 includes a post 1011 around which roll 1041 is placed. Tape 1040 can be unwound from supported roll 1041. A segment of the tape can be placed over window 1009, with the side of adhesive surface 1042 facing the ducts where air flow portions 1054, 1056 will become established. A filter support member 1043 is configured to maintain adhesive air filter 1040 substantially immobile, notwithstanding the pressure from the air flow. Accordingly, filter support member 1043 contributes to deflecting the air flow from the first direction of air flow portion 1054 to the second direction of air flow portion 1056. A small portion of the air flow may escape, if tape 1040 does not make contact with base structure 1010 around window 1009.

The dispenser arrangement of base structure 1010 further includes an opening 1016. A user may insert a finger in opening 1016 from the side of tape 1040 so as to grasp the end of tape 1040, lift it, and pull it. Pulling can unwind a fresh segment of tape 1040 from roll 1041, and thus replace the portion of tape 1040 that covers window 1009. Base structure 1010 further includes a blade 1017, from which a segment 1049 can be cut from the remainder of tape 1040 by a motion along arrow 1018. The cut segment 1049 has captured smaller particulates 1062, and can be discarded. In such embodiments, replacing the filter can be called “advancing the tape filter”.

Segment 1049 can be unwound and cut when particulates 1062 have saturated that sector of tape 1040. There are a number of ways of determining when saturation has been reached. In some embodiments, the concentration of particulates of a given size range is detected by detectors at portions of the air flow that are before and after the adhesive air filter. If the concentrations are similar, it would mean that it is time to replace the filter.

In other embodiments the adhesive air filter is inspected visually by humans or automatically. Inspection results are now described.

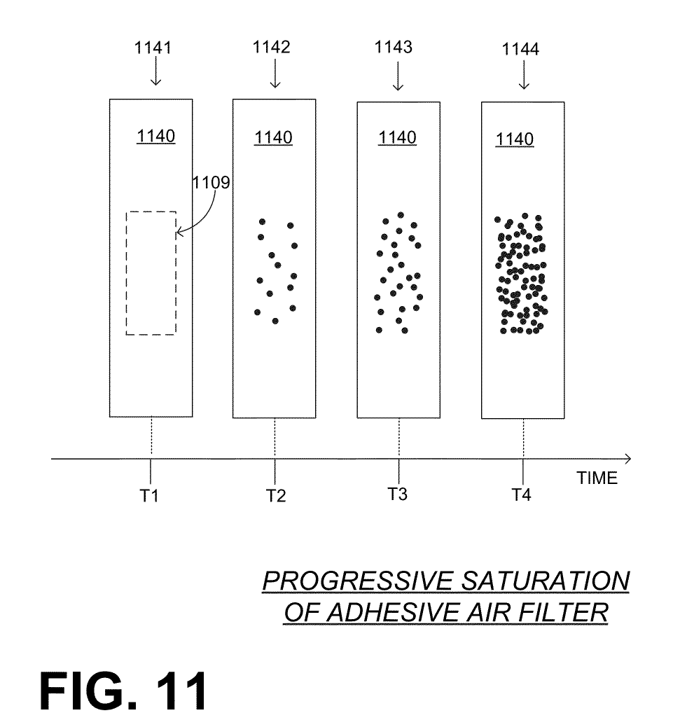

FIG. 11 is a time diagram for illustrating progressive saturation of an adhesive air filter. A horizontal axis shows time intercepts T1, T2, T3, T4. Time T1 shows a view 1141 of when a new portion of an adhesive air filter 1140 is placed over a window. An outline 1109 corresponds to the footprint of the window on adhesive air filter 1140.

Successive views 1142, 1143, 1144 of adhesive air filter 1140 are shown for respective subsequent times T2, T3, T4. These views show progressively more particulates captured by the adhesive surface, and accumulated within outline 1109. It should be noted that these particulates are the ones that passed through any filter such as filter 930 of FIG. 9, if provided. It should be further noted that the particulates of the size range of interest could be too small to be seen, but the concentration of any visible particulates can serve as an indicator as to the concentration of even very small particulates. In other words, a more likely time to replace adhesive air filter 1140 of FIG. 11 could be when it looks like view 1144 than view 1142. Moreover, the rating of filter 930 may be advantageously determined such that it does permit particulates that are large enough to be visible, so that the different views of FIG. 11 can be obtained.

The location of outline 1109 in view 1141 provides an additional insight. Outline 1109 shows where the corresponding window will be located. Accordingly, in some embodiments, tape 1140 will cover the window also from the side. Accordingly, filter support member 243 might not be needed.

The views of FIG. 11 are as would be seen from inside the duct. These are not easily accessible. This challenge can be overcome in a number of ways, as is now described.

Returning to FIG. 10, in some embodiments, adhesive air filter 1040 permits light to go through it. In other words, adhesive air filter 1040 can be translucent or even transparent. In these embodiments, if filter support member 1043 is also provided, then it can also permit light to go through it. Accordingly, adhesive surface 1042 of adhesive air filter 1040 can be inspected from the outside to see whether it appears more like view 1144 or view 1142. It would help if the inside of the ducts are of a light color, such as white.

In some embodiments, inspection is facilitated with illumination. For example, components 1000 also include a test light source 1046. Test light source 1046 can be configured to output test illumination that reaches adhesive surface 1042. Then it can be determined how much light passes through adhesive air filter 1040 and filter support member 1043. Test light source 1046 can be activated from a user interface (not shown) by a user. Further, activating test light source 1046 can tentatively automatically cause the fan to pause, and so on.

In some embodiments inspection is more automated. Inspection can happen at appropriate intervals, for example periodically. Examples are now described.

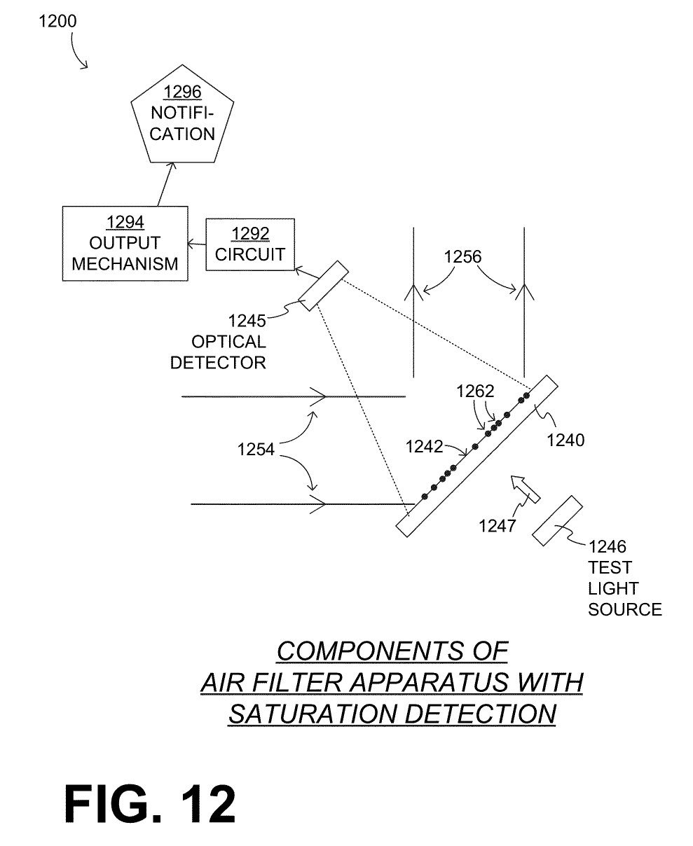

FIG. 12 is a diagram of components 1200 of an air filter apparatus made according to embodiments. Components 1200 include an adhesive air filter 1240 that has an adhesive surface 1242, and which can be similar to air filter 240. An air propulsion mechanism (not shown) establishes an air flow having portions 1254, 1256. Adhesive surface 1242 of air filter 1240 has captured a number of particulates 1262.

Components 1200 include an optical detector 1245. Optical detector 1245 can be a camera capable of capturing an image, a detector of light intensity, and so on. Optical detector 1245 can be configured to detect a feature of adhesive surface 1242. In some embodiments, the detected feature is an image of the adhesive surface, which could be as one of the views of FIG. 11. In other embodiments, the adhesive air filter permits light to go through it, and the detected feature is an amount of light that transverses the adhesive air filter 1240. To provide normalization, a test light source 1246 can be configured to output test illumination 1247 towards adhesive surface 1242. In such embodiments, the amount of light that transverses adhesive air filter 1240 includes test illumination 1247.

Components 1200 also include a circuit 1292. Circuit 1292 can be implemented by a processor, a microprocessor, a circuit including analog and digital signal processing, an application-specific integrated circuit, and so on. Circuit 1292 can be configured to provide an inspection output from the detected feature of adhesive surface 1242.

Components 1200 additionally include an output mechanism 1294. Output mechanism 1294 can be implemented in many ways, such as ways that draw the attention of a user or an attendant. Such ways include devices that emit human perceptible indications, for example a light, a buzzer, and so on. Output mechanism 1294 can be configured to provide a notification 1296 responsive to the inspection output of circuit 1292.

In some embodiments, notification 1296 is provided only if the inspection output meets a threshold condition. The threshold condition could be that the detected feature of adhesive surface 1242 indicates it is time to change the adhesive air filter 1240. For example, an overall image might be too dark, such as from view 1144, or not enough amount of light transverses adhesive air filter 1240.

In some embodiments, the air flow becomes disestablished while the feature of adhesive surface 1242 is being detected. For example, testing can discontinue the operation of the fan, which can improve the reliability of the detection.

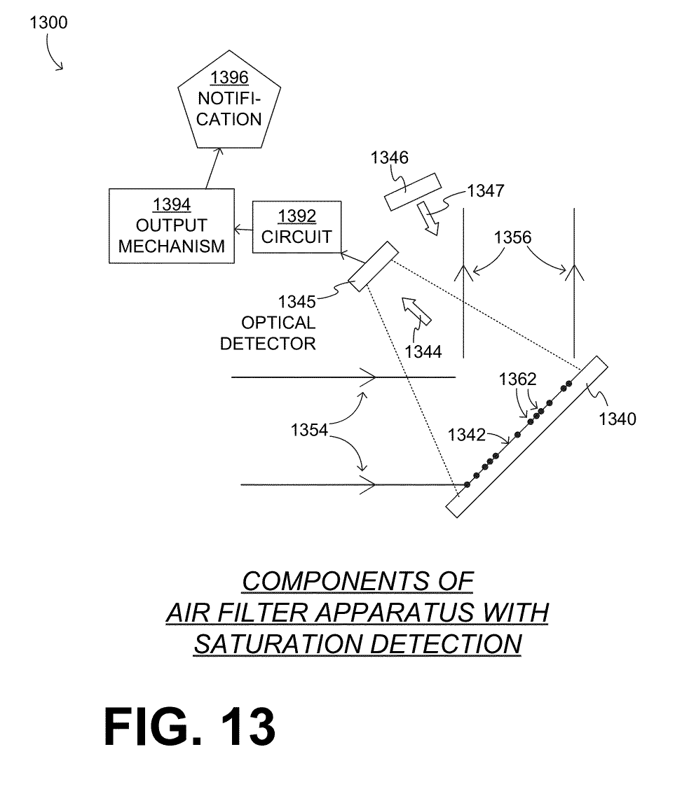

FIG. 13 is a diagram of components 1300 made according to embodiments. Components 1300 include an adhesive air filter 1340 that has an adhesive surface 1342, and which can be similar to air filter 240. An air propulsion mechanism (not shown) establishes an air flow having portions 1354, 1356. Adhesive surface 1342 of air filter 1340 has captured a number of particulates 1362.

Components 1300 include an optical detector 1345, which can be similar to optical detector 1245. To provide illumination, a test light source 1346 can be configured to output test illumination 1347 towards adhesive surface 1342.

Components 1300 also include a circuit 1392 and an output mechanism 1394, which can be similar to circuit 1292 and output mechanism 1294. Output mechanism 1394 can be configured to provide a notification 1396 responsive to the inspection output of circuit 1392.

In some embodiments, the filter is changed mechanically. This can be performed in a number of ways. Some of these ways include a motor to provide the motion. In embodiments where the adhesive air filter is provided in the form of a tape, saturated tape can be collected in a return bobbin. An example is now described.

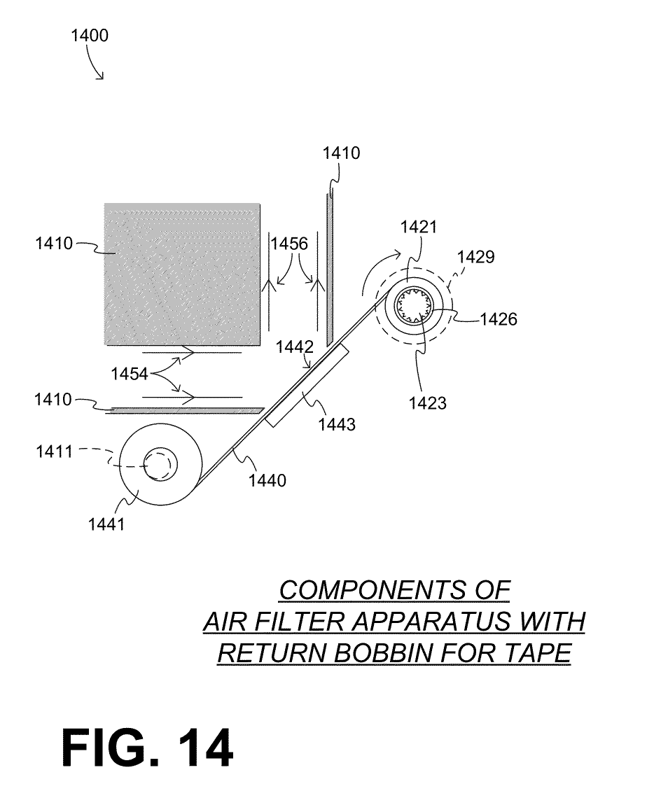

FIG. 14 is a diagram of components 1400 of an air filter apparatus according to embodiments. A base structure 1410 is provided, of which various parts are shown. Base structure 1410 defines ducts in which an air propulsion mechanism (not shown) can establish an air flow with portions 1454, 1456.

An adhesive air filter 1440 is provided in the form of a tape wound in a roll 1441. In the shown example, base structure 1410 includes a post 1411 around which roll 1441 is placed. Tape 1440 can be unwound from supported roll 1441, with the side of adhesive surface 1442 facing the ducts where air flow portions 1454, 1456 will become established. A filter support member 1443 is configured to maintain adhesive air filter 1440 substantially immobile, notwithstanding the pressure from the air flow.

Components 1400 also include a return bobbin 1426, and a motor 1429. Motor 1429 can be configured to rotate return bobbin 1426 along the direction of the curved arrow. Motor 1429 can be configured to engage return bobbin 1426, for example by presenting an axle 1423 with teeth that are received within matching teeth of return bobbin 1426.

While tape 1440 is wound in roll 1441, it has a first end that was free, and has been coupled to the return bobbin. Accordingly, the rotating return bobbin 1426 draws tape 1440 from roll 1441, and it forms a new roll 1421 of saturated tape. Drawing the tape, or advancing the tape, changes the filter mechanically. Care should be taken with the spacing so that the adhesive of tape 1440 does not impede drawing the tape.

There can be mechanisms for notifying the user when tape 1440 has finished, or is near finishing, and thus new tape is required. The mechanisms can include a buzzer, transmitting a message to a repair person, and so on. An air filter apparatus according to embodiments can recognize when that time comes in a number of ways. For example, it might know in advance how long the tape is, and keep count how much the tape has advanced. In embodiments, near the end of the available tape there can be a pattern that an optical detector recognizes and reacts accordingly.

Changing the filter mechanically permits maintaining a great distance of the user of the system from the filter. The distance can be physical, in terms of how easily the filter can be accessed. Indeed, the filter may be changed mechanically, by the user actuating a control mechanism, such as pressing a button, turning a knob, and so on. The distance can be also mental, in that the user need not learn advanced new skills, which would impede adoption.

In other embodiments, the filter is changed automatically. Change can be based on detection of the current filter effectiveness, as mentioned above. Change can be based on knowledge of how the system works, and how long it takes until a segment of the filter becomes saturated, and then changing accordingly. For example, a timer could be operated when the air propulsion mechanism is working. Changing the filter automatically further liberates the user from having to make frequent filter changes, or even worrying about them.

In some embodiments, the adhesive air filter is provided as a tape in a cassette. An example is now described.

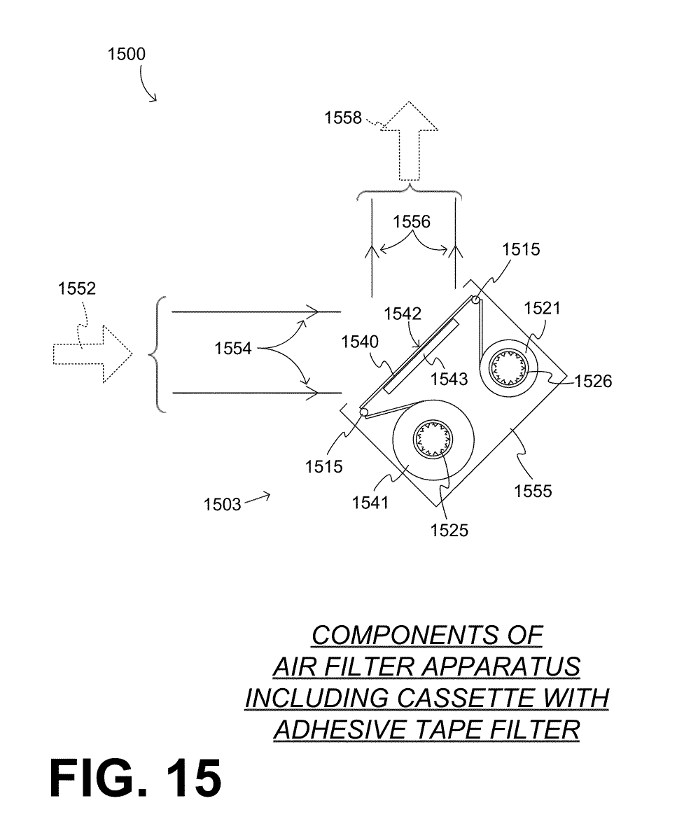

FIG. 15 is a diagram of sample components 1500 of an air filter apparatus made according to embodiments. Components 1500 include a base structure (not shown). An air propulsion mechanism (not shown) establishes an air flow having portions 1552, 1554, 1556, 1558.

Components 1500 also include a cassette 1503 made according to embodiments. Cassette 1503 includes a casing 1555, a supply bobbin 1525, and a return bobbin 1526. Bobbins 1525, 1526 are coupled to casing 1555 in a way that they can be rotated.

Components 1500 additionally include an oblong flat flexible tape 1540 that has a first end and a second end. The first end is coupled to supply bobbin 1525, and the second end is coupled to return bobbin 1526.

Tape 1540 is wound at least in part on supply bobbin 1525, forming roll 1541. In fact, when first sold, it could be wound on supply bobbin 1525 completely except for the second end. After it has been advanced a few times, some of tape 1540 will be wound on return bobbin 1526, forming a new roll 1521 of saturated tape.

Tape 1540 has two opposite sides. At least one of the sides has a surface 1542 that is coated with an adhesive. As mentioned above, commercially available adhesive tape can be used.

In some embodiments, casing 1555 includes posts 1515. Tape 1540 can be placed around posts 1515.

In some embodiments, casing 1555 includes an elongate filter support member 1543. Tape 1540 can be placed along filter support member 1543.

Components 1500 also include an opening in the base structure for inserting cassette 1503, a motor as described before for advancing return bobbin 1526, and so on.

In embodiments, the cassette is reusable for a clean roll of tape, as the spent tape is intended to be discarded. The cassette may be cleaned before reusing. Notifications about the tape ending can be as above.

Additional sample implementations are now described. The features and techniques described above apply also to the following sample implementations.

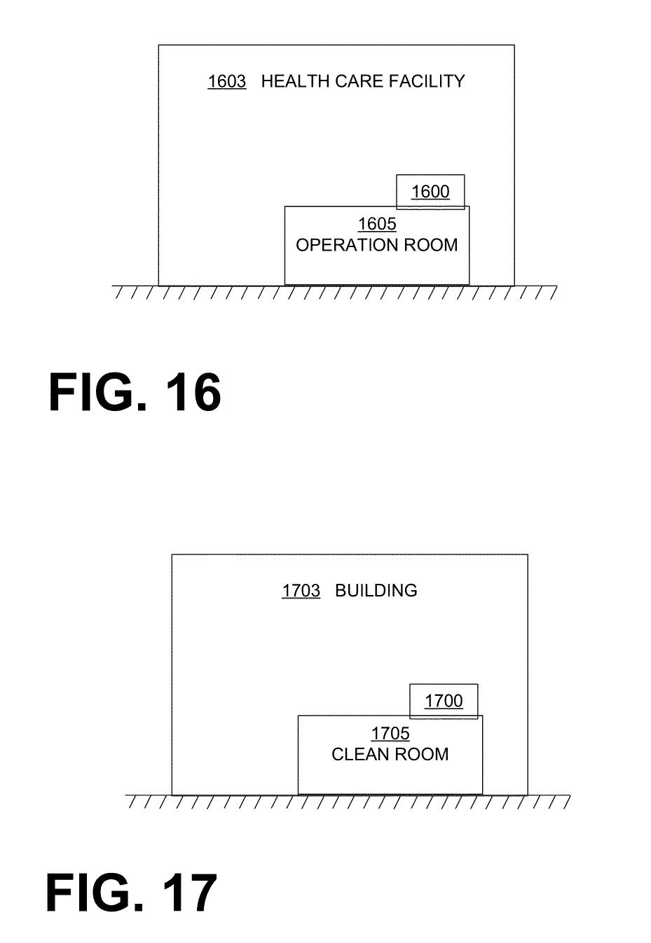

FIG. 16 is a diagram of a sample health care facility 1603, which for example could be a hospital. Health care facility 1603 has an operation room 1605, in which medical procedures may be performed on patients, such as surgeries. In such procedures, the patient may be vulnerable to contamination by airborne particulates. An air filter apparatus 1600 according to embodiments is used to remove particulates from the air. Air filter apparatus 1600 may optionally work in conjunction with the ventilation and filtration of clean room 1605.

FIG. 17 is a diagram of a sample building 1703. Building 1703 has a clean room 1705, in which sensitive industrial processes may be performed, such as manufacturing that is vulnerable to contamination by airborne particulates. An air filter apparatus 1700 according to embodiments is used to remove particulates from the air. Air filter apparatus 1700 may optionally work in conjunction with the ventilation and filtration of clean room 1705.

Many stand-alone embodiments are possible. Stand-alone embodiments can have many uses. Stand-alone embodiments can be portable and carried to enclosures where people live and work so as to protect them, for example in homes, offices, within vehicles, and also in industrial environments where pollutants are produced, such as by combustion. For integrating with processes that involve combustion, however, care has to be exercised to not permit the heat of the gases to destroy the adhesion air filter.

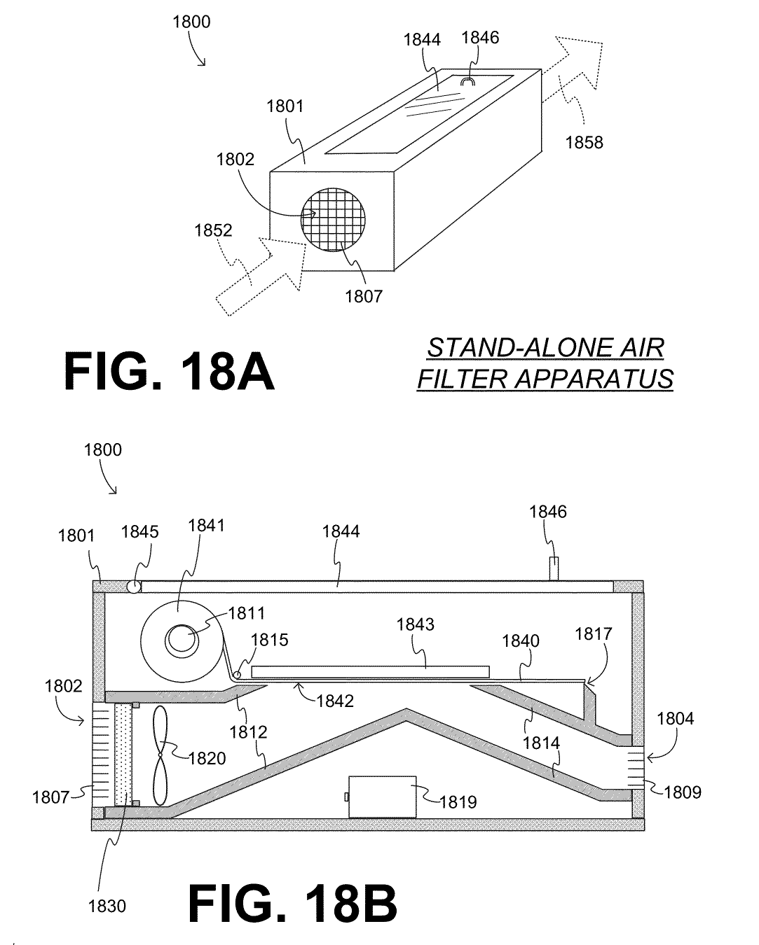

A simple small stand-alone unit made according to embodiments is now described. More complex ones can be made by adding features such as those described elsewhere in this document. FIG. 18A is a perspective diagram of a sample stand-alone air filter apparatus 1800 made according to embodiments, and FIG. 18B is a section side view of stand-alone air filter apparatus 1800. Stand-alone air filter apparatus 1800 can be configured to remove, from air that is in an enclosure and in which particulates are suspended, at least a fraction of the particulates.

Stand-alone air filter apparatus 1800 includes a housing 1801. Housing 1801 may have an intake opening 1802 and an exit opening 1804. Optionally, housing 1801 may have protective grilles 1807, 1809 respectively at intake opening 1802 and exit opening 1804.

Housing 1801 may also have a cover 1844 that can be opened by grasping handle 1846. Opening causes cover 1844 to rotate around a joint 1845. Cover 1844 may be opened to access adhesive air filter 1840 for replacement. Cover 1844 may stay shut by a latch mechanism (not shown).

Stand-alone air filter apparatus 1800 also includes a base structure within housing 1801. The base structure includes features such as a system of ducts 1812, 1814, and so on.

Stand-alone air filter apparatus 1800 additionally includes an adhesive air filter 1840 within housing 1801. Adhesive air filter 1840 is provided in the form of tape wound in a roll 1841, and which includes an adhesive surface 1842. In this sample embodiment, roll 1841 is ultimately supported on cover 1844. Accordingly, opening cover 1844 brings roll 1841 out of housing 1801 at least partially. In particular, roll 1841 is supported by a post 1811, which is attached to cover 1844. Bringing roll 1841 out of housing 1801 permits tape 1840 to be changed, and be wide without needing to make housing 1801 too wide. In other embodiments, post 1811 can be part of the base structure.

Filter support member 1843 can be attached to cover 1844, and thus be lifted when cover 1844 is opened. In addition, the base structure presents a dispenser arrangement. In particular, after roll 1811, dispensed tape 1840 can be placed around post 1815, and a blade 1817 can be used for cutting a portion of tape 1840 that has been saturated. The dispenser arrangement further has spaces for the user's fingers to grasp the end of tape 1840 and use blade 1817 as in FIG. 10. Cover 1844, filter support member 1843, and tape 1840 can be transparent, for determining when tape 1840 needs to be advanced by glancing through cover 1844, without needing to open it.

Stand-alone air filter apparatus 1800 moreover includes an air propulsion mechanism that is implemented by a fan 1820. Fan 1820 can be coupled to the base structure, and be configured to establish an air flow of the air in the enclosure that housing 1801 is taken to. Duct 1812 may have a small hole for power wires to go from fan 1820 to battery 1819. One of the power wires can be connected to an ON/OFF switch. In some embodiments, opening cover 1844 discontinues power to fan 1820, by suitable connection to the power wires.

Components 1800 furthermore include a transmissive air filter 1830. At least a part of the air flow is established to go through transmissive air filter 1830. Transmissive air filter 1830 can be replaced when saturated in a number of ways, such as by removing grille 1807.

In embodiments, the base structure is such that the air flow goes from intake opening 1802 past a vicinity of adhesive air filter 1840 and out of exit opening 1804. Accordingly, the air flow has portions 1852 and 1858 outside housing 1801, and additional portions inside ducts 1812 and 1814. Going past the vicinity of adhesive air filter 1840 may cause at least some of the particulates of the air in the air flow to impact adhesive surface 1842, and become adhered to it. In the shown example, upper duct 1812 is planar and horizontal for some distance, while lower duct 1812 is planar and raised from the horizontal by 22.5°. Particulates entering horizontally may be deflected by lower duct 1812 by a total angle of 2×22.5°=45°. This angle can cause them to impact adhesive surface 1842 at an incident angle of 45°, and put them en route to duct 1814. The side ducts (not shown) that are adjacent to ducts 1812 can be planar, with planes parallel to the plane of the drawing. If it is desired to use less wide tape 1840, these side ducts can also converge inward, for example by 22.5°.

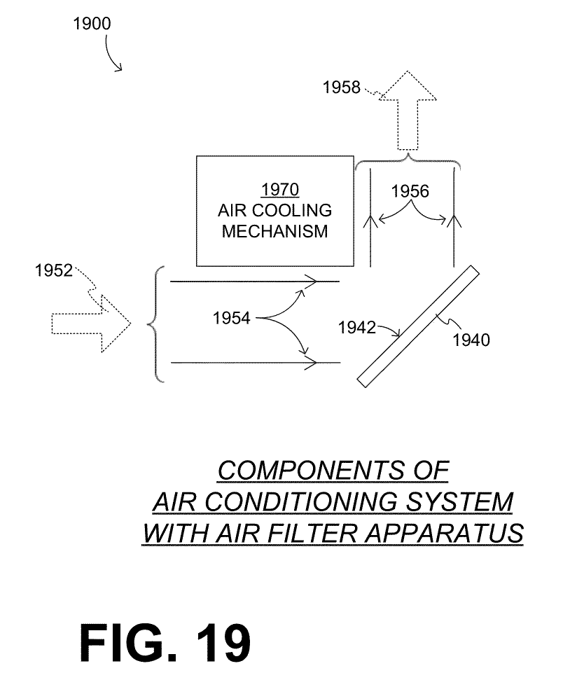

Embodiments further include air conditioning systems. Briefly, FIG. 19 is a diagram of sample components 1900 of an air conditioning system made according to embodiments. Components 1900 include an adhesive air filter 1940 that has an adhesive surface 1942, and which can be similar to air filter 240. An air propulsion mechanism (not shown) establishes an air flow having portions 1952, 1954, 1956, 1958. An air cooling mechanism 1970 cools the air at one or more points of the air flow.

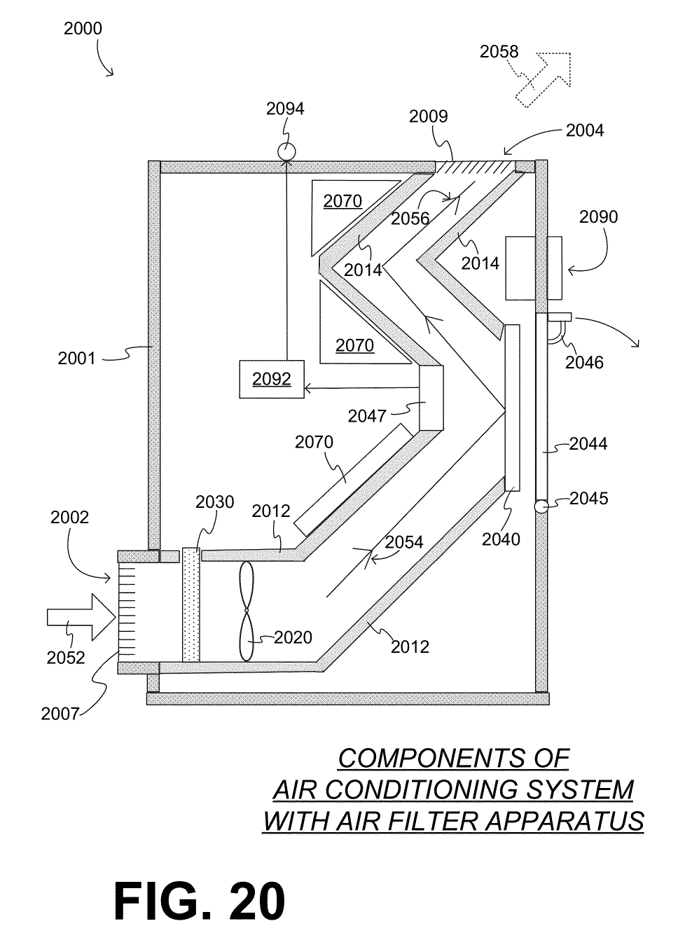

FIG. 20 is a diagram of sample components 2000 of an air conditioning system made according to embodiments. Components 2000 include a housing 2001. Housing 2001 may have an intake opening 2002 and an exit opening 2004. Optionally, housing 2001 may have protective grilles 2007, 2009 respectively at intake opening 2002 and exit opening 2004. In a number of embodiments, exit opening 2004 is inside a building, while intake opening 2002 communicates with the air outside the building.

Components 2000 also include a base structure within housing 2001. The base structure includes features such as a system of ducts 2012, 2014, and so on.

Components 2000 additionally include an adhesive air filter 2040 within housing 2001. Adhesive air filter 2040 could be implemented in many ways as described above, but such is not shown to reduce complexity.

Housing 2001 may also have a cover 2044 that can be opened by grasping handle 2046. Opening causes cover 2044 to rotate around a joint 2045. Cover 2044 may be opened to access adhesive air filter 2040 for replacement. Cover 2044 may stay shut by a latch mechanism (not shown).

Components 2000 moreover include an air propulsion mechanism that is implemented by a fan 2020. Fan 2020 can be coupled to the base structure, and be configured to establish an air flow of air within the housing. Particulates are suspended within the housing.

Components 2000 furthermore include a transmissive air filter 2030. At least a part of the air flow is established through transmissive air filter 2030. Transmissive air filter 2030 can be replaced when saturated by providing another opening in housing 2001 for this purpose (not shown).

In embodiments, the base structure is such that the air flow goes from intake opening 2002 past a vicinity of adhesive air filter 2040 and out of exit opening 2004. Accordingly, the air flow has portions 2052 and 2058 outside housing 2001, and portions 2054, 2056 inside ducts 2012, 2014 respectively. Going past the vicinity of adhesive air filter 2040 may cause at least some of the particulates of the air in the air flow to impact adhesive surface 2042, and become adhered to it.

Components 2000 further include an air cooling mechanism 2070. Air cooling mechanism 2070 can be configured to cool the air within housing 2001, at one or more points of the air flow. Components 2000 could further include a user interface 2090, which could be configured to control air cooling mechanism 2070 and other operations.

Components 2000 also include an optical detector 2047, which can be made as optical detector 1245. Components 2000 also include a circuit 2092 and an output mechanism 2094, which can be made as circuit 1292 and output mechanism 1294 respectively.

Embodiments further include air filter apparatuses for machines for human transportation. Some of these machines include cabins for passengers, whose air might be polluted once the doors are opened in a polluted location, and remain polluted during the next trip. Ground vehicles, such as automobiles, do not get the chance of cleaning the air unless they drive away from the polluted location and then lower their windows for ventilation.

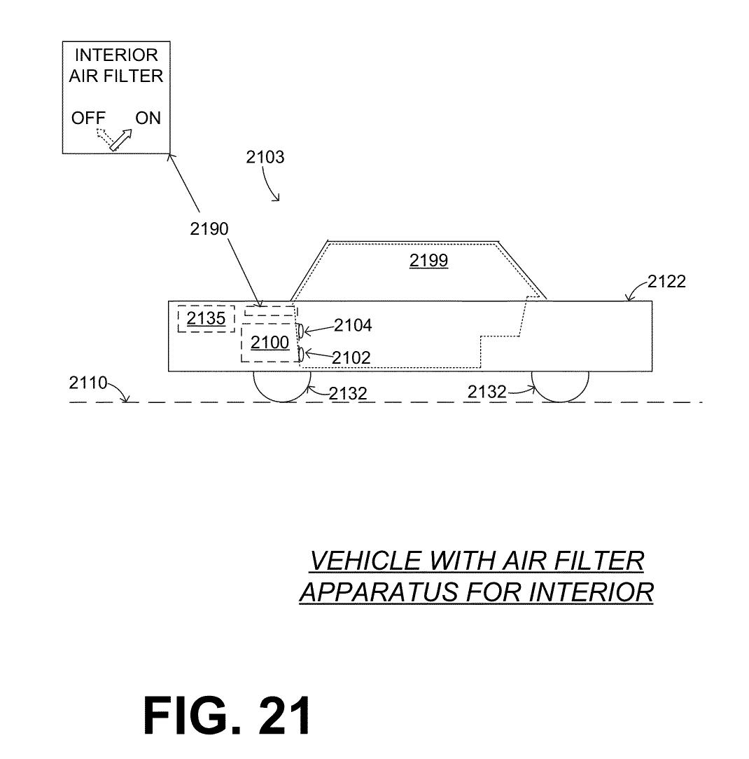

FIG. 21 is a diagram of a sample ground vehicle 2103 made according to embodiments. Sample vehicle 2103 is a passenger automobile, and embodiments can be applied to buses, trucks, trains, and so on.

Vehicle 2103 includes a body 2122. Body 2122 forms a passenger compartment 2199 that can be configured to receive people therein. Passenger compartment 2199 may contain air in which particulates are suspended.

Vehicle 2103 also includes wheels 2132 that are coupled to body 2122 in a way that they can rotate. Wheels 2132 are on ground 2110. Vehicle 2103 also includes an engine 2135. Engine 2135 can be configured to operate so as to cause wheels 2132 to rotate.

Vehicle 2103 additionally includes an air filter apparatus 2100. Air filter apparatus 2100 may be configured to remove from passenger compartment 2199 at least a fraction of the particulates in the air.

Air filter apparatus 2100 includes an intake opening 2102 and an exit opening 2104 that communicate with passenger compartment 2199. In embodiments, vehicle 2103 includes a dashboard, and exit opening 2104 is at the dashboard, so as to reach passengers faster. It is preferred to locate intake opening 2102 far from exit opening 2104. So, intake opening 2102 could be near the bottom of passenger compartment 2199, or right under the front windshield. Other embodiments of air filter apparatus 2100 may receive air from the outside and filter it.

Other components of air filter apparatus 2100 may be implemented as described previously, and are not shown in FIG. 21 so as not to clutter the drawing. These other components may include a base structure that defines ducts, etc., an adhesive air filter that includes an adhesive surface, and an air propulsion mechanism that is configured to establish an air flow of the air. Again, the base structure can be configured such that the air flow goes from intake opening 2102 past a vicinity of the adhesive air filter and out of exit opening 2104. At least some of the particulates of the air in the air flow may thus impact the adhesive surface and become adhered to the adhesive surface.

In embodiments, air filter apparatus 2100 is implemented in combination with the air heater or the air conditioning of vehicle 2103. For example, vehicle 2103 may further have a heater that is configured to heat air, and guide the heated air to passenger compartment 2199 via exit opening 2104. Additionally, vehicle 2103 may further have an air conditioner that is configured to cool air, and guide the cooled air to passenger compartment 2199 via exit opening 2104.

Moreover, vehicle 2103 may further have a user interface 2190, for example in the dashboard. User interface 2190 can be configured to be operated by one of the people in the passenger compartment, for example having the shown indications. Operating user interface 2190 can be configured to start or stop the air propulsion mechanism from working.

Other machines for human transportation include passenger airplanes. Again, once the doors are opened upon arrival at a polluted location, the cabin air can become polluted. Once the doors are closed for the next flight, they are not intended to be reopened for the duration of the flight. The cabin air might be purified from air filters made according to embodiments.

A person skilled in the art will be able to practice the present invention in view of this description, which is to be taken as a whole. Details have been included to provide a thorough understanding. In other instances, well-known aspects have not been described, in order to not obscure unnecessarily the present invention. Plus, any reference to any prior art in this description is not, and should not be taken as, an acknowledgement or any form of suggestion that this prior art forms parts of the common general knowledge in any country.

This description includes one or more examples, but that does not limit how the invention may be practiced. Indeed, examples or embodiments of the invention may be practiced according to what is described, or yet differently, and also in conjunction with other present or future technologies. Other embodiments include combinations and sub-combinations of features described herein, including for example, embodiments that are equivalent to: providing or applying a feature in a different order than in a described embodiment; extracting an individual feature from one embodiment and inserting such feature into another embodiment; removing one or more features from an embodiment; or both removing a feature from an embodiment and adding a feature extracted from another embodiment, while providing the features incorporated in such combinations and sub-combinations.

In this document, the phrase “configured to” denote one or more actual states of construction and/or configuration that is fundamentally tied to physical characteristics of the element or feature preceding these phrases. This element or feature can be implemented in any number of ways, as will be apparent to a person skilled in the art after reviewing the present disclosure, beyond any examples shown in this example.

The following claims define certain combinations and subcombinations of elements, features and steps or operations, which are regarded as novel and non-obvious. Additional claims for other such combinations and subcombinations may be presented in this or a related document. When used in the claims, the phrases “constructed to” and/or “configured to” reach well beyond merely describing an intended use, since such claims actively recite an actual state of construction and/or configuration based upon described and claimed structure.

The claimed invention is:

1. An air filter apparatus that is configured to remove, from air in which particulates are suspended, at least a fraction of the particulates, the air filter apparatus comprising:
a base structure;
an adhesive air filter coupled to the base structure that includes an adhesive surface; and
an air propulsion mechanism coupled to the base structure and configured to establish an air flow of the air, and
in which the base structure is configured such that the air flow goes past a vicinity of the adhesive air filter, and at least some of the particulates of the air in the air flow impact the adhesive surface and become adhered to the adhesive surface.

2. The air filter apparatus of claim 1, in which
the air is in an enclosure, and
the air flow goes from the enclosure, past the vicinity of the adhesive air filter, and then back to the enclosure.

3. The air filter apparatus of claim 1, in which
the air flow is deflected by the adhesive air filter from going substantially along a first direction to going substantially along a second direction that changes course by at least 30° from the first direction.

4. The air filter apparatus of claim 3, in which
the second direction changes course by approximately 90° from the first direction.

5. The air filter apparatus of claim 1, in which
the adhesive surface is configured to capture at least 3% of any of the particulates of the air in the air flow that impact the adhesive surface at a certain angle and belong in a size range.

6. The air filter apparatus of claim 1, in which
the adhesive surface is configured to capture at least 5% of any of the particulates of the air in the air flow that impact the adhesive surface at a certain angle and belong in a size range.

7. The air filter apparatus of claim 1, in which
the adhesive air filter is substantially impervious to air.

8. The air filter apparatus of claim 1, in which
the adhesive surface is substantially impervious to air.

9. The air filter apparatus of claim 1, in which
the adhesive air filter is flexible, and
further comprising: a filter support member configured to maintain the adhesive air filter substantially immobile notwithstanding the air flow.

10. The air filter apparatus of claim 9, in which
the filter support member permits light to go through it.

11. The air filter apparatus of claim 1, in which
the base structure includes a duct configured to confine at least a portion of the air flow.

12. The air filter apparatus of claim 11, in which
the duct is configured to progressively constrict at least a portion of the air flow.

13. The air filter apparatus of claim 11, in which
the duct is configured to cause at least some of the particulates within the air of the air flow to impact the adhesive surface at least twice.

14. The air filter apparatus of claim 1, further comprising:
a transmissive air filter, and
in which at least a part of the air flow is established through the transmissive air filter.

15. The air filter apparatus of claim 14, in which
the air flow is deflected by the adhesive air filter from going substantially along a first direction to going substantially along a second direction that changes course by at least 30° from the first direction.

16. The air filter apparatus of claim 14, in which
the adhesive air filter is substantially impervious to air.

17. The air filter apparatus of claim 14, in which
the adhesive air filter is flexible, and
further comprising: a filter support member configured to maintain the adhesive air filter substantially immobile notwithstanding the air flow.

18. The air filter apparatus of claim 14, in which
the adhesive air filter is provided in the form of tape wound in a roll, and
the base structure further includes a blade for cutting a segment of the tape.

19. The air filter apparatus of claim 14, in which
the adhesive air filter is provided in the form of tape wound in a roll, and
the base structure is further configured to support the roll.

20. The air filter apparatus of claim 14, further comprising:
an optical detector configured to detect a feature of the adhesive surface;
a circuit configured to provide an inspection output from the detected feature; and
an output mechanism configured to provide a notification responsive to the inspection output.

21. The air filter apparatus of claim 14, further comprising:
a return bobbin; and
a motor configured to rotate the return bobbin; and
in which the adhesive air filter is provided in the form of tape that is wound in a roll and has a first end that is coupled to the return bobbin, and
the rotating return bobbin draws the tape from the roll.

22. The air filter apparatus of claim 1, in which
the adhesive air filter is provided in the form of tape wound in a roll, and
the base structure further includes a blade for cutting a segment of the tape.

23. The air filter apparatus of claim 1, in which
the adhesive air filter is provided in the form of tape wound in a roll, and
the base structure is further configured to support the roll.

24. The air filter apparatus of claim 23, in which
the base structure further includes a blade for cutting the tape.

25. The air filter apparatus of claim 1, in which
the adhesive air filter permits light to go through it.

26. The air filter apparatus of claim 1, further comprising:
a test light source configured to output test illumination that reaches the adhesive surface.

27. The air filter apparatus of claim 1, further comprising:
an optical detector configured to detect a feature of the adhesive surface;
a circuit configured to provide an inspection output from the detected feature; and
an output mechanism configured to provide a notification responsive to the inspection output.

28. The air filter apparatus of claim 27, in which
the detected feature is an image of the adhesive surface.

29. The air filter apparatus of claim 27, in which
the adhesive air filter permits light to go through it, and
the detected feature is an amount of light that transverses the adhesive air filter.

30. The air filter apparatus of claim 29, further comprising:
a test light source configured to output test illumination that reaches the adhesive surface, and
in which the amount of light that transverses the adhesive air filter includes the test illumination.

31. The air filter apparatus of claim 27, in which
the notification is provided only if the inspection output meets a threshold condition.

32. The air filter apparatus of claim 27, in which
the air flow becomes disestablished while the feature is being detected.

33. The air filter apparatus of claim 27, further comprising:
a test light source configured to output test illumination that reaches the adhesive surface.

34. The air filter apparatus of claim 1, further comprising:
a return bobbin; and
a motor configured to rotate the return bobbin; and
in which the adhesive air filter is provided in the form of tape that is wound in a roll and has a first end that is coupled to the return bobbin, and
the rotating return bobbin draws the tape from the roll.

35. A cassette, comprising:
a casing;
a supply bobbin and a return bobbin coupled to the casing in a way that they can be rotated; and
an oblong flat flexible tape having a first end coupled to the supply bobbin and a second end coupled to the return bobbin, the tape wound at least in part on the supply bobbin, the tape having two opposite sides, at least one of the sides having a surface coated with an adhesive.

36. The cassette of claim 35, in which
the casing includes a post, and
the tape is placed around the post.

37. The cassette of claim 35, in which
the casing includes an elongate filter support member, and
the tape is placed along the filter support member.

38. A stand-alone air filter apparatus that is configured to remove, from air that is in an enclosure and in which particulates are suspended, at least a fraction of the particulates, the stand-alone air filter apparatus comprising:
a housing having an intake opening and an exit opening;
a base structure within the housing;
an adhesive air filter within the housing that includes an adhesive surface; and
an air propulsion mechanism coupled to the base structure and configured to establish an air flow of the air, and
in which the base structure is configured such that the air flow goes from the intake opening past a vicinity of the adhesive air filter and out of the exit opening, and at least some of the particulates of the air in the air flow impact the adhesive surface and become adhered to the adhesive surface.

39. The stand-alone air filter apparatus of claim 38, in which
the housing includes a cover that can be opened,
the adhesive air filter is provided in the form of tape wound in a roll,
the roll is ultimately supported on the cover, and
opening the cover brings the roll out of the housing at least partially.

40. The stand-alone air filter apparatus of claim 38, in which
the air flow is deflected by the adhesive air filter from going substantially along a first direction to going substantially along a second direction that changes course by at least 30° from the first direction.

41. The stand-alone air filter apparatus of claim 40, in which
the second direction changes course by approximately 90° from the first direction.

42. The stand-alone air filter apparatus of claim 38, in which
the adhesive surface is configured to capture at least 3% of any of the particulates of the air in the air flow that impact the adhesive surface at a certain angle and belong in a size range.

43. The air filter apparatus of claim 38, in which
the adhesive surface is configured to capture at least 5% of any of the particulates of the air in the air flow that impact the adhesive surface at a certain angle and belong in a size range.

44. The stand-alone air filter apparatus of claim 38, in which
the adhesive air filter is substantially impervious to air.

45. The stand-alone air filter apparatus of claim 38, in which
the adhesive surface is substantially impervious to air.

46. The stand-alone air filter apparatus of claim 38, in which
the adhesive air filter is flexible, and
further comprising: a filter support member configured to maintain the adhesive air filter substantially immobile notwithstanding the air flow.

47. The stand-alone air filter apparatus of claim 46, in which
the filter support member permits light to go through it.

48. The stand-alone air filter apparatus of claim 38, in which
the base structure includes a duct configured to confine at least a portion of the air flow.

49. The stand-alone air filter apparatus of claim 48, in which
the duct is configured to progressively constrict at least a portion of the air flow.

50. The stand-alone air filter apparatus of claim 48, in which
the duct is configured to cause at least some of the particulates within the air of the air flow to impact the adhesive surface at least twice.

51. The stand-alone air filter apparatus of claim 38, further comprising:
a transmissive air filter, and
in which at least a part of the air flow is established through the transmissive air filter.

52. The stand-alone air filter apparatus of claim 51, in which
the air flow is deflected by the adhesive air filter from going substantially along a first direction to going substantially along a second direction that changes course by at least 30° from the first direction.

53. The stand-alone air filter apparatus of claim 51, in which
the adhesive air filter is substantially impervious to air.

54. The stand-alone air filter apparatus of claim 51, in which
the adhesive air filter is flexible, and
further comprising: a filter support member configured to maintain the adhesive air filter substantially immobile notwithstanding the air flow.

55. The stand-alone air filter apparatus of claim 51, in which
the adhesive air filter is provided in the form of tape wound in a roll, and
the base structure further includes a blade for cutting a segment of the tape.

56. The stand-alone air filter apparatus of claim 51, in which
the adhesive air filter is provided in the form of tape wound in a roll, and
the base structure is further configured to support the roll.

57. The stand-alone air filter apparatus of claim 51, further comprising:
an optical detector configured to detect a feature of the adhesive surface;
a circuit configured to provide an inspection output from the detected feature; and
an output mechanism configured to provide a notification responsive to the inspection output.

58. The stand-alone air filter apparatus of claim 51, further comprising:
a return bobbin; and
a motor configured to rotate the return bobbin; and
in which the adhesive air filter is provided in the form of tape that is wound in a roll and has a first end that is coupled to the return bobbin, and
the rotating return bobbin draws the tape from the roll.

59. The stand-alone air filter apparatus of claim 38, in which
the adhesive air filter is provided in the form of tape wound in a roll, and
the base structure further includes a blade for cutting a segment of the tape.

60. The stand-alone air filter apparatus of claim 38, in which
the adhesive air filter is provided in the form of tape wound in a roll, and
the base structure is further configured to support the roll.

61. The stand-alone air filter apparatus of claim 60, in which
the base structure further includes a blade for cutting the tape.

62. The stand-alone air filter apparatus of claim 38, in which
the adhesive air filter permits light to go through it.

63. The stand-alone air filter apparatus of claim 38, further comprising:
a test light source configured to output test illumination that reaches the adhesive surface.

64. The stand-alone air filter apparatus of claim 38, further comprising:
an optical detector configured to detect a feature of the adhesive surface;
a circuit configured to provide an inspection output from the detected feature; and
an output mechanism configured to provide a notification responsive to the inspection output.

65. The stand-alone air filter apparatus of claim 64, in which
the detected feature is an image of the adhesive surface.

66. The stand-alone air filter apparatus of claim 64, in which
the adhesive air filter permits light to go through it, and
the detected feature is an amount of light that transverses the adhesive air filter.

67. The stand-alone air filter apparatus of claim 66, further comprising:
a test light source configured to output test illumination that reaches the adhesive surface, and
in which the amount of light that transverses the adhesive air filter includes the test illumination.

68. The stand-alone air filter apparatus of claim 64, in which
the notification is provided only if the inspection output meets a threshold condition.

69. The stand-alone air filter apparatus of claim 64, in which
the air flow becomes disestablished while the feature is being detected.

70. The stand-alone air filter apparatus of claim 64, further comprising:
a test light source configured to output test illumination that reaches the adhesive surface.

71. The stand-alone air filter apparatus of claim 38, further comprising:
a return bobbin; and
a motor configured to rotate the return bobbin; and
in which the adhesive air filter is provided in the form of tape that is wound in a roll and has a first end that is coupled to the return bobbin, and
the rotating return bobbin draws the tape from the roll.

72. An air conditioning system, comprising:
a housing having an intake opening and an exit opening;
a base structure;
an air propulsion mechanism coupled to the base structure and configured to establish an air flow of air within the housing, and in which particulates are suspended;
an air cooling mechanism configured to cool the air within the housing; and
an adhesive air filter that includes an adhesive surface, and
in which the base structure is configured such that the air flow goes from the intake opening past a vicinity of the adhesive air filter and out of the exit opening, and at least some of the particulates of the air in the air flow impact the adhesive surface and become adhered to the adhesive surface.

73. The air conditioning system of claim 72, further comprising:
an air heating mechanism configured to heat the air within the housing.

74. The air conditioning system of claim 72, in which
the air flow is deflected by the adhesive air filter from going substantially along a first direction to going substantially along a second direction that changes course by at least 30° from the first direction.

75. The air conditioning system of claim 74, in which
the second direction changes course by approximately 90° from the first direction.

76. The air conditioning system of claim 72, in which
the adhesive surface is configured to capture at least 3% of any of the particulates of the air in the air flow that impact the adhesive surface at a certain angle and belong in a size range.

77. The air conditioning system of claim 72, in which
the adhesive surface is configured to capture at least 5% of any of the particulates of the air in the air flow that impact the adhesive surface at a certain angle and belong in a size range.

78. The air conditioning system of claim 72, in which
the adhesive air filter is substantially impervious to air.

79. The air conditioning system of claim 72, in which
the adhesive surface is substantially impervious to air.

80. The air conditioning system of claim 72, in which
the adhesive air filter is flexible, and
further comprising: a filter support member configured to maintain the adhesive air filter substantially immobile notwithstanding the air flow.

81. The air conditioning system of claim 80, in which
the filter support member permits light to go through it.

82. The air conditioning system of claim 72, in which
the base structure includes a duct configured to confine at least a portion of the air flow.

83. The air conditioning system of claim 82, in which
the duct is configured to progressively constrict at least a portion of the air flow.

84. The air conditioning system of claim 82, in which
the duct is configured to cause at least some of the particulates within the air of the air flow to impact the adhesive surface at least twice.

85. The air conditioning system of claim 72, further comprising:
a transmissive air filter, and
in which at least a part of the air flow is established through the transmissive air filter.

86. The air conditioning system of claim 85, in which
the air flow is deflected by the adhesive air filter from going substantially along a first direction to going substantially along a second direction that changes course by at least 30° from the first direction.

87. The air conditioning system of claim 85, in which
the adhesive air filter is substantially impervious to air.

88. The air conditioning system of claim 85, in which
the adhesive air filter is flexible, and
further comprising: a filter support member configured to maintain the adhesive air filter substantially immobile notwithstanding the air flow.

89. The air conditioning system of claim 85, in which
the adhesive air filter is provided in the form of tape wound in a roll, and
the base structure further includes a blade for cutting a segment of the tape.

90. The air conditioning system of claim 85, in which
the adhesive air filter is provided in the form of tape wound in a roll, and
the base structure is further configured to support the roll.

91. The air conditioning system of claim 85, further comprising:
an optical detector configured to detect a feature of the adhesive surface;
a circuit configured to provide an inspection output from the detected feature; and
an output mechanism configured to provide a notification responsive to the inspection output.

92. The air conditioning system of claim 85, further comprising:
a return bobbin; and
a motor configured to rotate the return bobbin; and
in which the adhesive air filter is provided in the form of tape that is wound in a roll and has a first end that is coupled to the return bobbin, and
the rotating return bobbin draws the tape from the roll.

93. The air conditioning system of claim 72, in which
the adhesive air filter is provided in the form of tape wound in a roll, and
the base structure further includes a blade for cutting a segment of the tape.

94. The air conditioning system of claim 72, in which
the adhesive air filter is provided in the form of tape wound in a roll, and
the base structure is further configured to support the roll.

95. The air conditioning system of claim 94, in which
the base structure further includes a blade for cutting the tape.

96. The air conditioning system of claim 72, in which
the adhesive air filter permits light to go through it.

97. The air conditioning system of claim 72, further comprising:
a test light source configured to output test illumination that reaches the adhesive surface.

98. The air conditioning system of claim 72, further comprising:
an optical detector configured to detect a feature of the adhesive surface;
a circuit configured to provide an inspection output from the detected feature; and
an output mechanism configured to provide a notification responsive to the inspection output.

99. The air conditioning system of claim 98, in which
the detected feature is an image of the adhesive surface.

100. The air conditioning system of claim 98, in which
the adhesive air filter permits light to go through it, and
the detected feature is an amount of light that transverses the adhesive air filter.
The air conditioning system of claim 100, further comprising:
a test light source configured to output test illumination that reaches the adhesive surface, and
in which the amount of light that transverses the adhesive air filter includes the test illumination.

101. The air conditioning system of claim 98, in which
the notification is provided only if the inspection output meets a threshold condition.

102. The air conditioning system of claim 98, in which
the air flow becomes disestablished while the feature is being detected.

103. The air conditioning system of claim 98, further comprising:
a test light source configured to output test illumination that reaches the adhesive surface.

104. The air conditioning system of claim 72, further comprising:
a return bobbin; and
a motor configured to rotate the return bobbin; and
in which the adhesive air filter is provided in the form of tape that is wound in a roll and has a first end that is coupled to the return bobbin, and
the rotating return bobbin draws the tape from the roll.

105. A vehicle, comprising:
a body that forms a passenger compartment that is configured to receive people therein, the passenger compartment containing air in which particulates are suspended;
wheels coupled to the body in a way that they can rotate;
an engine configured to operate so as to cause the wheels to rotate; and
an intake opening and an exit opening that communicate with the passenger compartment;
a base structure;
an adhesive air filter that includes an adhesive surface; and
an air propulsion mechanism configured to establish an air flow of the air, and
in which the base structure is configured such that the air flow goes from the intake opening past a vicinity of the adhesive air filter and out of the exit opening, and at least some of the particulates of the air in the air flow impact the adhesive surface and become adhered to the adhesive surface.

106. The vehicle of claim 105, further comprising:
a dashboard, and
in which the exit opening is at the dashboard.

107. The vehicle of claim 105, further comprising:
a heater configured to heat air, and guide the heated air to the passenger compartment via the exit opening.

108. The vehicle of claim 105, further comprising:
an air conditioner configured to cool air, and guide the cooled air to the passenger compartment via the exit opening.

109. The vehicle of claim 105, further comprising:
a user interface configured to be operated by one of the people in the passenger compartment, and
in which operating the interface is configured to one of start and stop the air propulsion mechanism from working.

110. The vehicle of claim 105, in which
the air flow is deflected by the adhesive air filter from going substantially along a first direction to going substantially along a second direction that changes course by at least 30° from the first direction.

111. The vehicle of claim 110, in which
the second direction changes course by approximately 90° from the first direction.

112. The vehicle of claim 105, in which
the adhesive surface is configured to capture at least 3% of any of the particulates of the air in the air flow that impact the adhesive surface at a certain angle and belong in a size range.

113. The air filter apparatus of claim 105, in which
the adhesive surface is configured to capture at least 5% of any of the particulates of the air in the air flow that impact the adhesive surface at a certain angle and belong in a size range.

114. The vehicle of claim 105, in which
the adhesive air filter is substantially impervious to air.

115. The vehicle of claim 105, in which
the adhesive surface is substantially impervious to air.

116. The vehicle of claim 105, in which
the adhesive air filter is flexible, and
further comprising: a filter support member configured to maintain the adhesive air filter substantially immobile notwithstanding the air flow.

117. The vehicle of claim 116, in which
the filter support member permits light to go through it.

118. The vehicle of claim 105, in which
the base structure includes a duct configured to confine at least a portion of the air flow.

119. The vehicle of claim 118, in which
the duct is configured to progressively constrict at least a portion of the air flow.

120. The vehicle of claim 118, in which
the duct is configured to cause at least some of the particulates within the air of the air flow to impact the adhesive surface at least twice.

121. The vehicle of claim 105, further comprising:
a transmissive air filter, and
in which at least a part of the air flow is established through the transmissive air filter.

122. The vehicle of claim 121, in which
the air flow is deflected by the adhesive air filter from going substantially along a first direction to going substantially along a second direction that changes course by at least 30° from the first direction.

123. The vehicle of claim 121, in which
the adhesive air filter is substantially impervious to air.

124. The vehicle of claim 121, in which
the adhesive air filter is flexible, and
further comprising: a filter support member configured to maintain the adhesive air filter substantially immobile notwithstanding the air flow.

125. The vehicle of claim 121, in which
the adhesive air filter is provided in the form of tape wound in a roll, and
the base structure further includes a blade for cutting a segment of the tape.

126. The vehicle of claim 121, in which
the adhesive air filter is provided in the form of tape wound in a roll, and
the base structure is further configured to support the roll.

127. The vehicle of claim 121, further comprising:
an optical detector configured to detect a feature of the adhesive surface;
a circuit configured to provide an inspection output from the detected feature; and
an output mechanism configured to provide a notification responsive to the inspection output.

128. The vehicle of claim 121, further comprising:
a return bobbin; and
a motor configured to rotate the return bobbin; and
in which the adhesive air filter is provided in the form of tape that is wound in a roll and has a first end that is coupled to the return bobbin, and
the rotating return bobbin draws the tape from the roll.

129. The vehicle of claim 105, in which
the adhesive air filter is provided in the form of tape wound in a roll, and
the base structure further includes a blade for cutting a segment of the tape.

130. The vehicle of claim 105, in which
the adhesive air filter is provided in the form of tape wound in a roll, and
the base structure is further configured to support the roll.

131. The vehicle of claim 130, in which
the base structure further includes a blade for cutting the tape.

132. The vehicle of claim 105, in which
the adhesive air filter permits light to go through it.

133. The vehicle of claim 105, further comprising:
a test light source configured to output test illumination that reaches the adhesive surface.

134. The vehicle of claim 105, further comprising:
an optical detector configured to detect a feature of the adhesive surface;
a circuit configured to provide an inspection output from the detected feature; and
an output mechanism configured to provide a notification responsive to the inspection output.

135. The vehicle of claim 134, in which
the detected feature is an image of the adhesive surface.

136. The vehicle of claim 134, in which
the adhesive air filter permits light to go through it, and
the detected feature is an amount of light that transverses the adhesive air filter.

137. The vehicle of claim 136, further comprising:
a test light source configured to output test illumination that reaches the adhesive surface, and
in which the amount of light that transverses the adhesive air filter includes the test illumination.

138. The vehicle of claim 134, in which
the notification is provided only if the inspection output meets a threshold condition.

139. The vehicle of claim 134, in which
the air flow becomes disestablished while the feature is being detected.

140. The vehicle of claim 134, further comprising:
a test light source configured to output test illumination that reaches the adhesive surface.

141. The vehicle of claim 105, further comprising:
a return bobbin; and
a motor configured to rotate the return bobbin; and
in which the adhesive air filter is provided in the form of tape that is wound in a roll and has a first end that is coupled to the return bobbin, and
the rotating return bobbin draws the tape from the roll.
